(19) United States
(12) Patent Application Publication
(10) Pub. No.: US 2012/0081622 A1
(43) Pub. Date: Apr. 5, 2012

(54) WAVE PLATE AND POLARIZATION CONVERSION ELEMENT, ILLUMINATION OPTICAL SYSTEM, AND IMAGE DISPLAY DEVICE THAT USE WAVE PLATE

(75) Inventors: Ryoko Horikoshi, Kanagawa (JP); Hideki Yamamoto, Kanagawa (JP)

(73) Assignee: SONY CORPORATION, Tokyo (JP)

(21) Appl. No.: 13/236,804

(22) Filed: Sep. 20, 2011

(30) Foreign Application Priority Data
Sep. 30, 2010 (JP) P2010-221508

(51) Int. Cl. G02F 1/13357; F21V 9/14; G02F 1/13363; G02B 27/28

(52) U.S. Cl. 349/9; 359/489.07; 362/19

(57) ABSTRACT

Disclosed herein is a wave plate including: a first quartz plate configured to have a crystal optical axis inclined to a major surface; and a second quartz plate configured to have a crystal optical axis inclined to a major surface, the major surface of the second quartz plate being superimposed on the major surface of the first quartz plate, wherein an angle formed by the optical axis of the first quartz plate and the optical axis of the second quartz plate is 45 degrees in a front view seen from direction perpendicular to the major surface, and the optical axis of the first quartz plate is parallel to the optical axis of the second quartz plate in a top view seen from direction parallel to the major surface.

### BACKGROUND

The present disclosure relates to a wave plate that changes the polarization direction of transmitted light, and a polarization conversion element, an illumination optical system, and an image display device that each use the wave plate.

In the projection-type image display device (projector) of the related art, a polarization conversion element is used in order to enhance the use efficiency of light. For this polarization conversion element, a half-wave plate is used in order to change the polarization direction of light.

The half-wave plate for this use purpose is desired to carry out favorable polarization conversion for the whole of the wavelengths in the visible range, and a half-wave plate for a wide band is used.

As the material of the half-wave plate, a film of polycarbonate or the like is generally used. However, for example Japanese Patent No. 4277514 (hereinafter, Patent Document 1) proposes a quartz wave plate for improving the heat resistance and the light resistance. In Patent Document 1, a wave plate is configured by stacking two quartz plates. In particular, according to Patent Document 1, band broadening can be achieved by configuring the wave plate in such a manner that θ2=θ1+45 and 0<θ1<45 are satisfied when θ1 is the angle formed by the polarization plane of incident linearly-polarized light and the optical axis of the first wave plate and θ2 is the angle formed by the polarization plane of incident linearly-polarized light and the optical axis of the second wave plate.

Japanese Patent Laid-open No. 2009-133917 (hereinafter, Patent Document 2) discloses a technique in which two same quartz plates are so bonded to each other as to be shifted from each other by 45 degrees and one quartz plate is so disposed as to form an angle of 22.5 degrees with the reference plane.

By thus disposing the quartz plates, a wave plate having a bias in the viewing angle characteristic is configured. In the technique of Patent Document 2, this viewing angle characteristic is effectively utilized by changing the arrangement in this wave plate.

### SUMMARY

However, in the technique of Patent Document 1, the phase difference generated by each of two quartz plates changes depending on the incident angle of the incident light beam. Therefore, the deviations of the phase difference in two quartz plates need to be cancelled out and complex design is required.

Furthermore, to suppress wavelength dispersion and luminance lowering and achieve the optical performance equivalent to that of a half-wave plate formed of a film, the thickness of the quartz plate needs to be set as thin as possible. However, when the thickness becomes thinner, difficulty in processing increases and the influence on the yield and cost becomes larger.

It will be effective to employ a method like that described in Patent Document 2. Specifically, in this method, the design of the quartz wave plate is simplified and the thickness of the quartz plate is increased. In addition, overall optimization is attempted based on the way of disposing the wave plate in an illumination optical system and a polarization conversion element.

However, variation often occurs in the optical performance of the wave plate if the wave plate is configured merely by bonding two same quartz plates to each other with shift by 45 degrees and disposing one quartz plate in such a manner the quartz plate forms an angle of 22.5 degrees with the reference plane, like in Patent Document 2.

There is a need for a technique to provide a wave plate that has favorable polarization conversion efficiency free from variation and can be easily manufactured, a polarization conversion element, an illumination optical system, and an image display device.

According to an embodiment of the present disclosure, there is provided a wave plate including a first quartz plate configured to have a crystal optical axis inclined to a major surface, and a second quartz plate configured to have a crystal optical axis inclined to a major surface. The major surface of the second quartz plate is superimposed on the major surface of the first quartz plate.

Furthermore, the angle formed by the optical axis of the first quartz plate and the optical axis of the second quartz plate is 45 degrees in a front view seen from direction perpendicular to the major surface, and the optical axis of the first quartz plate is parallel to the optical axis of the second quartz plate in a top view seen from direction parallel to the major surface.

According to the embodiment of the present disclosure, two quartz plates are so disposed that the optical axis directions of these quartz plates are parallel to each other when the quartz plates are seen from the direction parallel to the major surface of the wave plate or the quartz plate. Specifically, this embodiment is based on a finding that the orientations of two optical axes seen from the direction parallel to the major surface have a large influence on the optical characteristics of the wave plate and the light wavelength dependence of the polarization conversion efficiency can be reduced to the maximum extent by configuring the wave plate in such a manner that these two optical axes are parallel to each other. Furthermore, the incident angle dependence of the polarization conversion efficiency for light whose incident angle is on the negative side smaller than 0 degrees can also be reduced.

According to another embodiment of the present disclosure, there is provided a polarization conversion element including a polarization splitter configured to split incident light into p-polarized light and s-polarized light, and a wave plate configured to be disposed on the optical path of one of the p-polarized light and the s-polarized light split by the polarization splitter. As this wave plate, the above-described wave plate is used.

Therefore, also in this polarization conversion element, the wavelength dependence and incident angle dependence of the polarization conversion efficiency can be reduced.

According to another embodiment of the present disclosure, there is provided an illumination optical system including a light source, and an integrator element configured to reduce illuminance unevenness of light emitted from the light source.

Furthermore, the illumination optical system includes also a polarization conversion element configured to be disposed on the optical path of light transmitted through the integrator element and include a polarization splitter that splits incident light into p-polarized light and s-polarized light and a wave plate disposed on the optical path of one of the p-polarized light and the s-polarized light split by the polarization splitter. As this polarization conversion element, the above-described polarization conversion element is used.

According to the illumination optical system of one embodiment of the present disclosure, polarization conversion of light having wide wavelength range and incident angle is carried out for the light source because the above-described polarization conversion element is used. This can provide illumination light brighter than that of the related art.

According to another embodiment of the present disclosure, there is provided an image display device including the above-described illumination optical system, a light-splitting optical system configured to split light output from the illumination optical system, a liquid crystal panel configured to modulate the split light, a light combiner configured to combine light modulated by the liquid crystal panel, and a lens configured to project light combined by the light combiner.

According to the image display device of one embodiment of the present disclosure, an image can be generated with high efficiency with respect to light from the light source because the above-described illumination optical system is used. Therefore, brighter images can be provided at low power consumption.

According to the embodiments of the present disclosure, the wave plate is so configured that the optical axis directions of two quartz plates are parallel to each other when the quartz plates are seen from the direction parallel to the major surface of the wave plate or the quartz plate. Thus, the incident angle dependence and the wavelength dependence are reduced and favorable polarization conversion efficiency free from variation can be achieved.

### BRIEF DESCRIPTION OF THE DRAWINGS

FIG. 1A is a top view when a wave plate according to a first embodiment is seen from the direction parallel to its major surface, and FIG. 1B is a front view seen from the direction perpendicular to the major surface;

FIG. 2A is a top view when a wave plate of a related art is seen from the direction parallel to its major surface, and FIG. 2B is a front view seen from the direction perpendicular to the major surface;

FIG. 3 is an explanatory diagram showing the incident angle of light incident on the wave plate in one embodiment of the present disclosure;

FIG. 4A shows the light transmittance in parallel Nicols obtained by simulation about the wave plate according to the first embodiment, and FIG. 4B shows the light transmittance in crossed Nicols;

FIG. 5A shows the light transmittance in parallel Nicols obtained by simulation about the wave plate of the related art, and FIG. 5B shows the light transmittance in crossed Nicols;

FIG. 6A is a schematic diagram when experimentally-fabricated quartz plates are seen from the direction parallel to their major surfaces, and FIG. 6B is a schematic diagram seen from the direction perpendicular to the major surfaces;

FIG. 7A is a schematic diagram when the wave plate according to the first embodiment configured with the experimentally-fabricated quartz plates is seen from the direction parallel to its major surface, and FIG. 7B is a schematic diagram seen from the direction perpendicular to the major surface;

FIG. 8A is a schematic diagram when the wave plate of the related art configured with the experimentally-fabricated quartz plates is seen from the direction parallel to its major surface, and FIG. 8B is a schematic diagram seen from the direction perpendicular to the major surface;

FIG. 9 is an explanatory diagram showing how the transmittance of the fabricated wave plate is measured;

FIG. 10A shows actual measurement values of the light transmittance in parallel Nicols about the wave plate according to the first embodiment, and FIG. 10B shows actual measurement values of the light transmittance in crossed Nicols;

FIG. 11A shows actual measurement values of the light transmittance in parallel Nicols about the wave plate of the related art, and FIG. 11B shows actual measurement values of the light transmittance in crossed Nicols;

FIG. 12A shows actual measurement values obtained by measuring the light transmittance in parallel Nicols about the wave plate according to the first embodiment fabricated by bonding quartz plates to each other, and FIG. 12B shows actual measurement values obtained by measuring the light transmittance in crossed Nicols;

FIG. 13 is a schematic configuration diagram showing a polarization conversion element according to a second embodiment;

FIG. 14A is a front view of the polarization conversion element according to the second embodiment, and

FIGS. 14B and 14C are explanatory diagrams showing arrangement of wave plates configuring the polarization conversion element according to the second embodiment;

FIGS. 15A to 15H are explanatory diagrams showing combinations of the wave plates in the polarization conversion element according to the second embodiment;

FIG. 16 is a schematic configuration diagram showing an illumination optical system according to a third embodiment; and

FIG. 17 is a schematic configuration diagram showing an image display device according to a fourth embodiment.

### DETAILED DESCRIPTION OF THE PREFERRED EMBODIMENTS

Examples of the best mode for carrying out the present disclosure will be described below. However, the present disclosure is not limited to the following examples. The order of the description is as follows.

1. First Embodiment (Example of Wave Plate)

2. Second Embodiment (Example of Polarization Conversion Element)

3. Third Embodiment (Example of Illumination Optical System)

4. Fourth Embodiment (Example of Image Display Device)

First, the coordinate system in the present specification will be defined. In the present specification, the description will be made based on the right hand coordinate system. The X- and Y-axes in the drawings are defined as directions in the wave plate surface, and the Z-axis is defined as the thickness direction of the wave plate. Furthermore, when this wave plate is put on a desk and viewed from above, the right hand side is defined as the X-axis positive direction and the upper side is defined as the Y-axis position direction. In addition, the direction from the area under the desk toward the upper side is defined as the z-axis positive direction.

In the case of performing optical calculation about this wave plate, the calculation is performed based on the assumption that typically light is incident on the wave plate from the smaller-value side of the Z-axis and passes through the wave plate toward the larger-value side of the Z-axis.

Furthermore, the X-axis direction is defined as the polarization direction of the incident light.

### 1. First Embodiment

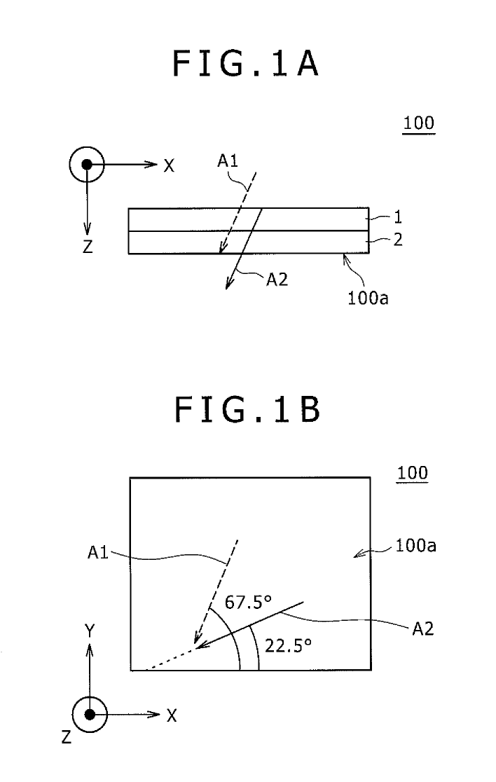

FIGS. 1A and 1B are schematic diagrams showing the schematic configuration of a wave plate 100 according to a first embodiment and is represented based on trigonometry.

FIG. 1A is a top view when the wave plate 100 is seen from the direction parallel to its major surface 100a. FIG. 1B is a front view when the wave plate 100 according to the first embodiment is seen from the direction perpendicular to its major surface 100a.

As shown in FIG. 1A, the wave plate 100 according to the present embodiment has a configuration in which the major surface of a first quartz plate 1 and the major surface of a second quartz plate 2 are superimposed.

In the diagram, an arrow A1 indicates the optical axis direction of the quartz plate 1, and an arrow A2 indicates the optical axis direction of the quartz plate 2. The optical axis is referred to also as the C-axis. The direction indicated by the arrow in the present specification is as follows. Specifically, in a front view like FIG. 1B, the tip of the optical axis on the arrowhead side indicates the anterior side, i.e. the side closer to the viewer. This applies also to the other diagrams in the present specification.

Furthermore, in the present specification, the azimuth refers to the angle formed by the optical axis and the polarization direction of the incident light (X-axis) when the wave plate is seen from the direction perpendicular to the major surface of the quartz plate, and is irrespective of the orientation of the optical axis in the thickness direction of the quartz plate (Z-axis direction). Therefore, the azimuth is the same also when the arrowhead of the arrow A1 in FIG. 1B is oriented toward the 180 degrees opposite direction in the XY plane for example.

As shown by the arrows A1 and A2 in FIG. 1A, the optical axis of the first quartz plate 1 and the optical axis of the second quartz plate 2 are inclined to the major surface 100a in the top view seen from the direction parallel to the major surface 100a of the wave plate 100, i.e. from the direction perpendicular to the polarization direction of the incident light (X-axis). That is, the first quartz plate 1 and the second quartz plate 2 are formed by cutting the plates in such a manner that the optical axis of the crystal is set oblique, i.e. by so-called Z-cut, and even one quartz plate can function as a zero-order half-wave plate.

Furthermore, in this top view, the optical axis of the first quartz plate 1 and the optical axis of the second quartz plate 2 are almost parallel to each other.

As shown in FIG. 1B, in the front view when the wave plate 100 is seen from the direction perpendicular to the major surface 100a, the angle formed by the optical axis of the first quartz plate 1 and the optical axis of the second quartz plate 2 is 45 degrees. It is preferable that the azimuth of the optical axis of the first quartz plate 1 with respect to the X-axis direction, which is defined as the polarization direction of the incident light, be set to 67.5 degrees and the azimuth of the optical axis of the second quartz plate 2 be set to 22.5 degrees.

As just described, in the present embodiment, the optical axis of the first quartz plate 1 and the optical axis of the second quartz plate 2 are set almost parallel to each other in the top view seen from the direction parallel to the major surface 100a of the wave plate 100, i.e. from the direction perpendicular to the polarization direction of the incident light (X-axis). In the related art, consideration is given only to the optical axis direction in the wave plate surface like in Patent Document 1 for example.

However, in the case of cutting a plate in such a manner that the optical axis of the quartz is set oblique in order to allow one quartz plate to function as a zero-order half-wave plate, the optical axis of the quartz plate is three-dimensionally inclined. Therefore, consideration should be given not only to the direction of the optical axis in the front view seen from the direction perpendicular to the major surface, shown in FIG. 1B, but also to the direction of the optical axis in the top view seen from the direction parallel to the major surface like FIG. 1A.

The embodiment of the present disclosure is based on a finding that band broadening can be easily achieved by configuring two quartz plates in such a manner that the directions of the optical axis in the top view seen from the direction parallel to the major surface of the wave plate are parallel to each other.

Furthermore, in the present embodiment, the same quartz plate can be used as the first quartz plate 1 and the second quartz plate 2. Specifically, the wave plate can be configured by rotating the quartz plate in a direction in the major surface and superimposing the major surfaces on each other in such a manner that the angle formed by the optical axes of two same quartz plates in the front view is 45 degrees and the optical axes are parallel to each other in the top view.

This eliminates the need to manufacture plural kinds of quartz plates and thus makes it possible to simplify the manufacturing step and reduce the cost.

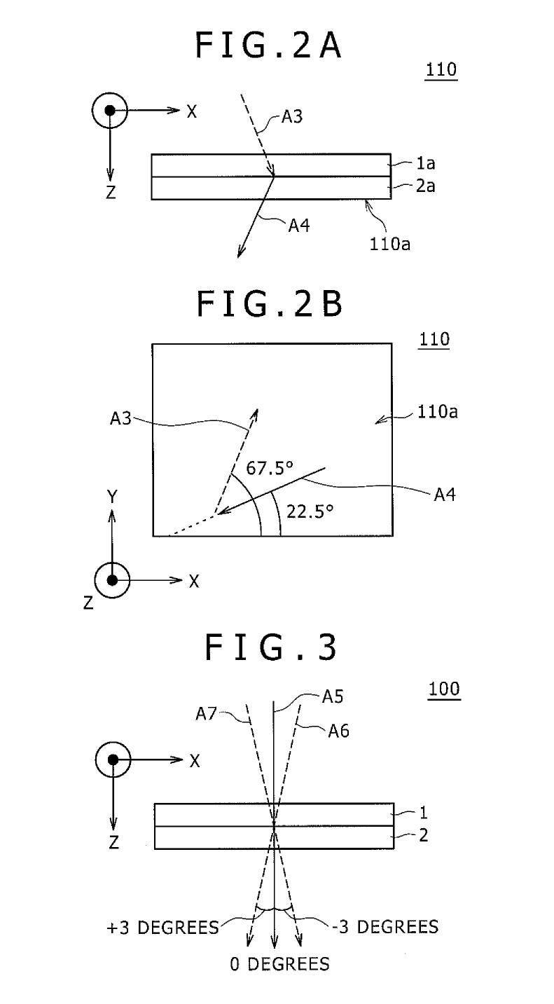

A simulation was performed about the case in which light having the polarization direction along the X-axis direction was incident on this wave plate 100. Furthermore, as a comparative example, a simulation was similarly performed also about a wave plate 110 shown in FIGS. 2A and 2B.

FIG. 2B is a front view when the wave plate 110 is seen from the direction perpendicular to a major surface 110a of the wave plate 110. FIG. 2A is a top view when the wave plate 110 is seen from the direction that is parallel to the major surface 110a and perpendicular to the polarization direction of the incident light.

As shown in FIG. 2A, this wave plate 110 is configured by superimposing the major surfaces of a first quartz plate 1a and a second quartz plate 2a on each other.

In the diagram, an arrow A3 indicates the optical axis direction of the first quartz plate 1a, and an arrow A4 indicates the optical axis direction of the second quartz plate 2a. As shown in FIG. 2B, in the front view seen from the direction perpendicular to the major surface 110a of the wave plate 110, the azimuths of the optical axis of the first quartz plate 1a and the optical axis of the second quartz plate 2a are 67.5 degrees and 22.5 degrees, respectively, similarly to the wave plate 100 according to the present embodiment shown in FIGS. 1A and 1B.

However, as shown in FIG. 2A, when the wave plate 110 is seen from the top view direction, which is parallel to the major surface 110a and perpendicular to the polarization direction of the incident light, the optical axis of the first quartz plate 1a and the optical axis of the second quartz plate 2a are along directions intersecting each other.

In the simulation, a 25-degree Z-cut wafer obtained by cutting at 25 degrees with respect to the optical axis of the quartz was used as the quartz plates 1 and 2 and the quartz plates 1a and 2a. The thickness of the wafer was set to about 0.15 mm so that 180 degrees might be obtained as the phase difference for light that was incident at an incident angle of 0 degrees and had a wavelength of 480 nm.

Specifically, the quartz plates 1, 2, 1a, and 2a were the same quartz plate and were rotated in a direction in the major surface to be superimposed on each other in such a manner that the azimuths of the optical axis were set to 67.5 degrees and 22.5 degrees as described above.

Furthermore, because the quartz is a crystal, the simulation was performed by using a liquid crystal simulator.

To investigate the performance as a half-wave plate, polarization plates were disposed on the incidence side and the output side of the wave plate, and calculation was performed for each of the case in which these polarization plates were in parallel Nicols and the case in which they were in crossed Nicols.

The respective polarization plates were so disposed that the polarization direction of the light that had passed through the polarization plate on the incidence side corresponded with the X-axis direction of the wave plates 100 and 110. The light that has passed through the half-wave plate has the polarization direction rotated by 90 degrees. Thus, in parallel Nicols, the light that has passed through the wave plate is blocked by the polarization plate disposed on the output side. Therefore, it can be said that the polarization conversion efficiency of the wave plate is higher when the transmittance of the light after the passage through the polarization plate disposed on the output side with respect to the light after the transmission through the polarization plate disposed on the incidence side is lower.

In crossed Nicols, the polarization direction of the light that has passed through the wave plate corresponds with the polarization axis direction of the polarization plate disposed on the output side. Therefore, it can be said that the polarization conversion efficiency of the wave plate is higher when the transmittance of the light after the passage through the polarization plate disposed on the output side with respect to the light after the transmission through the polarization plate disposed on the incidence side is higher.

In the simulation, the transmittance was obtained about three patterns in which the incident angle of light to the respective wave plates was set to −3 degrees, 0 degrees, and +3 degrees.

As shown by an arrow A5 in FIG. 3, the incident angle of light perpendicular to the major surface of the wave plate 100 is defined as 0 degrees. Furthermore, as shown by an arrow A6, the incident angle of a light beam that is inclined to the major surface of the wave plate 100 and travels from the X-axis positive side toward the negative side is defined as a positive angle. As shown by an arrow A7, the incident angle of a light beam that is inclined and travels from the X-axis negative side toward the positive side is defined as a negative angle.

This applies also to the wave plate 110.

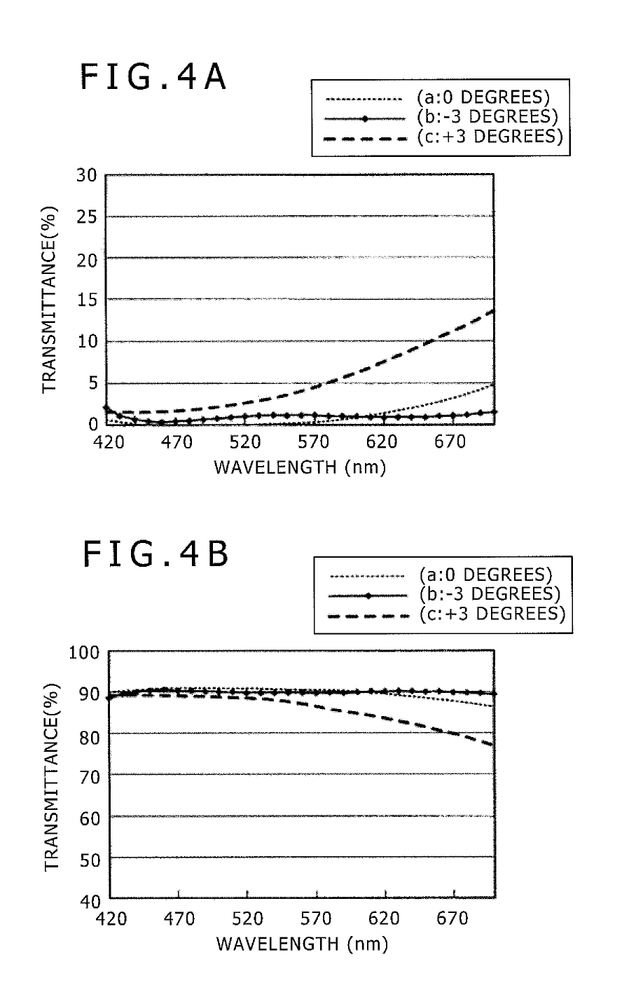

FIGS. 4A and 4B show the result of the above-described simulation performed about the wave plate 100 according to the present embodiment. FIG. 4A shows the transmittance in parallel Nicols. FIG. 4B shows the transmittance in crossed Nicols.

Lines a, b, and c correspond to the cases in which the incident angle of a light beam to the wave plate 100 is 0 degrees, −3 degrees, and +3 degrees, respectively.

As shown in FIG. 4A, in parallel Nicols, the transmittance of the light whose incident angle is −3 degrees takes low values almost equivalent to those of the transmittance of the light whose incident angle is 0 degrees, and high conversion efficiency is obtained from both incident angles in a wide band from a wavelength of 420 nm to 700 nm. If the incident angle of light is +3 degrees, the transmittance is higher on the longer wavelength side.

As shown in FIG. 4B, also in crossed Nicols, the transmittance of the light whose incident angle is −3 degrees takes high values almost equivalent to those of the transmittance of the light whose incident angle is 0 degrees, and high conversion efficiency is obtained from both incident angles in a wide band from a wavelength of 420 nm to 700 nm. In the case of the light whose incident angle is +3 degrees, the transmittance is lower for light whose wavelength is longer.

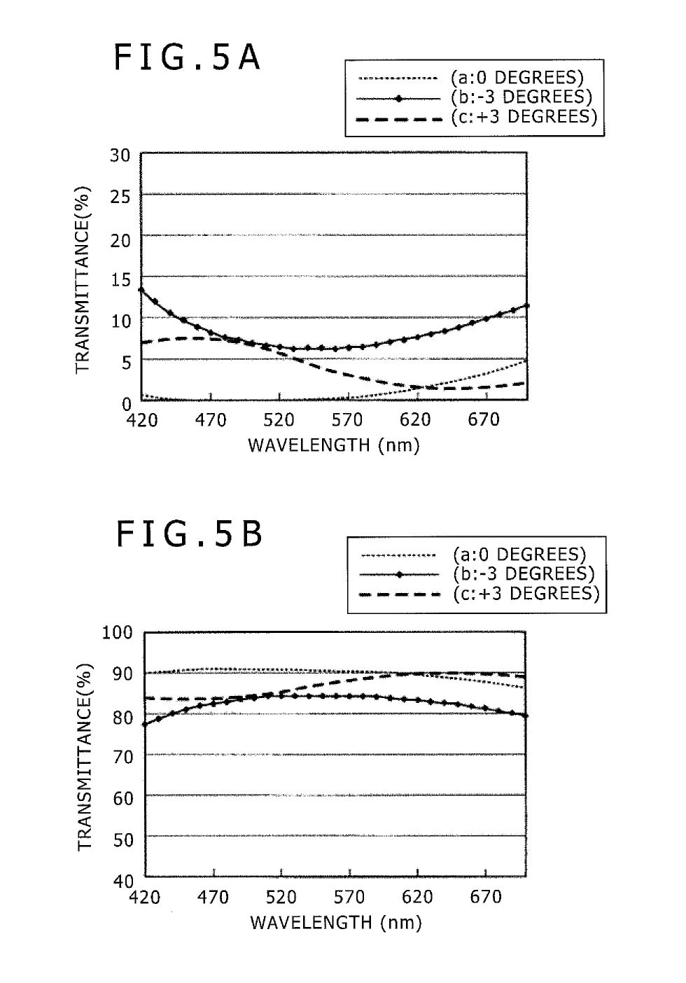

FIGS. 5A and 5B show the simulation result of the wave plate 110, which was configured by superimposing two quartz plates on each other in such a manner that the optical axes intersected each other in the top view seen from the direction parallel to their major surfaces.

FIG. 5A shows the transmittance in parallel Nicols. FIG. 5B shows the transmittance in crossed Nicols.

Lines a, b, and c correspond to the cases in which the incident angle of a light beam to the wave plate 110 is 0 degrees, −3 degrees, and +3 degrees, respectively.

As shown in FIG. 5A, in parallel Nicols, the transmittance of the light whose incident angle is 0 degrees takes almost the same values as those of the wave plate 100 according to the present embodiment. However, the transmittance of the light whose incident angle is −3 degrees takes high values totally irrespective of the wavelength. Thus, it can be confirmed that, in the wave plate 100 of the present embodiment, the conversion efficiency of light whose incident angle is on the negative side is improved compared with this wave plate 110 of the related art.

For the light whose incident angle is +3 degrees, the transmittance is higher on the shorter wavelength side.

As shown in FIG. 5B, in crossed Nicols, the transmittance of the light whose incident angle is 0 degrees takes almost the same values as those of the wave plate 100 according to the present embodiment. However, the transmittance of the light whose incident angle is −3 degrees is at most about 84%. Therefore, by comparison with FIG. 4B, it can be confirmed that the conversion efficiency of light whose incident angle is on the negative side is improved in the wave plate 100 according to the present embodiment.

The transmittance of the light whose incident angle is +3 degrees is lower on the shorter wavelength side.

As just described, in the wave plate 110 of the related art, both the wavelength dependence and the incident angle dependence of the transmittance exist. In contrast, in the wave plate 100 according to the present embodiment, the light whose incident light is −3 degrees exhibits the transmittance that does not have the wavelength dependence and is equivalent to that of the light whose incident angle is 0 degrees as shown in FIGS. 4A and 4B. That is, it can be said that, by the wave plate 100 of the present embodiment, high conversion efficiency with reduced incident angle dependence and wavelength dependence can be realized for light whose incident angle is a negative angle.

In particular, in an optical system using a wave plate, a bias often arises in the intensity distribution of light as a function of the incident angle of the light due to the lens configuration in this optical system and so forth. In such a case, polarization conversion can be carried out with higher efficiency by using the wave plate 100 according to the present embodiment and disposing the wave plate with rotation in its surface so that light having high intensity may be incident at an incident angle on the negative side smaller than 0 degrees.

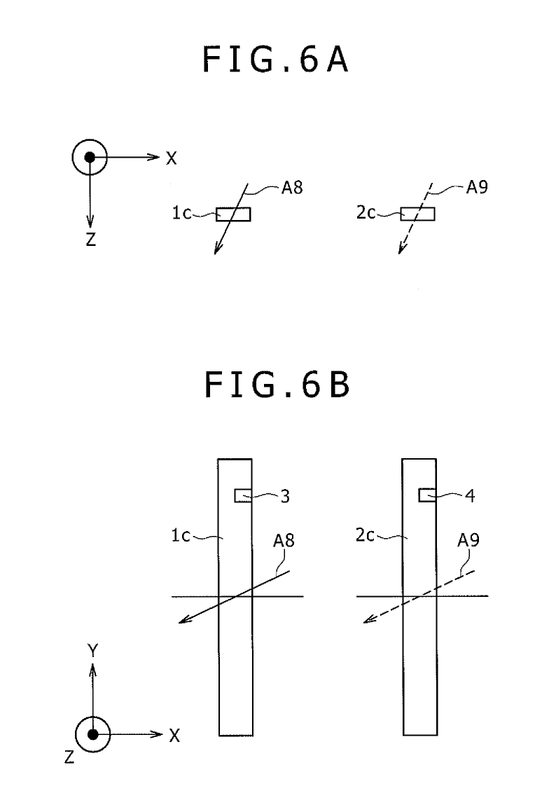

The result of verification of these simulation results through actual manufacturing of the wave plate and measurement will be described below with reference to FIGS. 6A to 12B.

First, as shown in FIGS. 6A and 6B, a first quartz plate 1c and a second quartz plate 2c each having a rectangular shape were cut out. These quartz plates 1c and 2c were the same quartz plate. Similarly to the simulation, they were obtained by Z-cut at 25 degrees with respect to the optical axis and their thickness was set to about 0.15 mm so that 180 degrees might be obtained as the phase difference for light that was incident at an incident angle of 0 degrees and had a wavelength of 480 nm.

FIG. 6B is a front view when the first quartz plate 1c and the second quartz plate 2c are seen from the direction perpendicular to the major surfaces. FIG. 6A is a top view seen from the direction parallel to the major surfaces.

An arrow A8 indicates the optical axis direction of the first quartz plate 1c. An arrow A9 indicates the optical axis direction of the second quartz plate 2c. In both the first quartz plate 1c and the second quartz plate 2c, the azimuth of the optical axis with respect to the polarization direction of the incident light (X-axis) is 22.5 degrees.

Trenches 3 and 4 were made on the major surfaces of the first quartz plate 1c and the second quartz plate 2c in order to discriminate the front and back sides of the quartz plate.

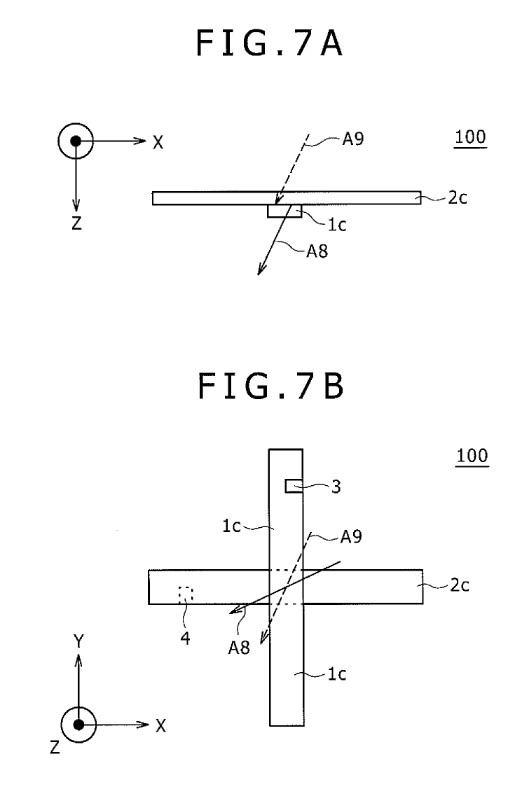

FIGS. 7A and 7B are schematic diagrams of the wave plate 100 according to the present embodiment configured by superimposing the first quartz plate 1c and the second quartz plate 2c.

FIG. 7B is a front view seen from the direction perpendicular to the major surface of the wave plate 100 (major surfaces of the quartz plates 1c and 2c). FIG. 7A is a top view seen from the direction parallel to the major surface.

As shown in FIG. 7B, the second quartz plate 2c is rotated in a direction in its major surface by 90 degrees. The trench 4 of the second quartz plate 2c is shown by a dotted line in FIG. 7B. This means that the trench 4 is disposed on the back side of the second quartz plate 2c in FIG. 7B. Specifically, the second quartz plate 2c shown in FIG. 7B results from reversal of the front and back sides of the second quartz plate 2c shown in FIG. 6B and anticlockwise rotation thereof by 90 degrees in the diagram.

By thus configuring the wave plate 100, the azimuth of the optical axis of the second quartz plate 2c in the front view is set to 67.5 degrees. The azimuth of the optical axis of the first quartz plate 1c is 22.5 degrees. Furthermore, as shown in FIG. 7A, the optical axes of the respective quartz plates are parallel to each other in the top view seen from the direction parallel to the major surface.

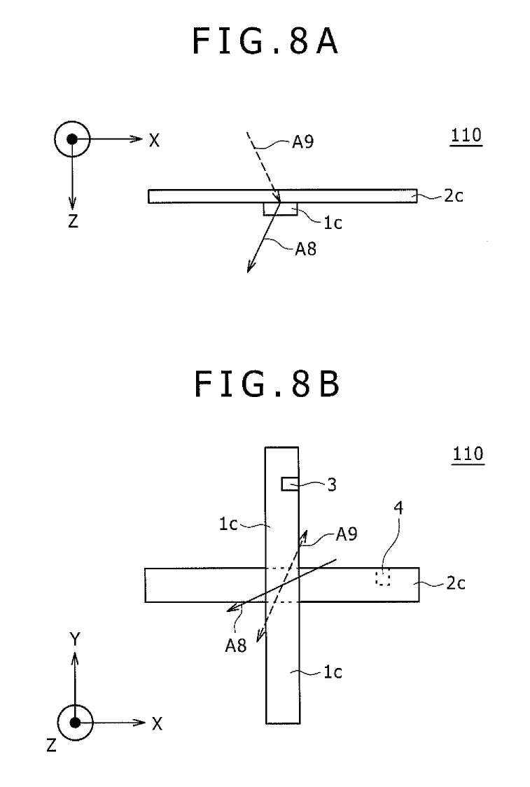

FIGS. 8A and 8B are schematic diagrams showing the wave plate 110 of the related art (see FIG. 2) configured by superimposing the first quartz plate 1c and the second quartz plate 2c.

FIG. 8B is a front view seen from the direction perpendicular to the major surface of the wave plate 110 (major surfaces of the quartz plates 1c and 2c). FIG. 8A is a top view seen from the direction parallel to this major surface.

As shown in FIG. 8B, the second quartz plate 2c is rotated in a direction in its major surface by 90 degrees in a clockwise manner in the diagram. Furthermore, as shown by the trench 4 represented by a dotted line, the second quartz plate 2c shown in FIG. 8B results from reversal of the front and back sides of the second quartz plate 2c shown in FIG. 6B.

If the wave plate 110 is thus configured, although the azimuth of the optical axis of the second quartz plate 2c in the front view is set to 67.5 degrees, the optical axis of the second quartz plate 2c in the top view is oriented in a direction intersecting the optical axis of the first quartz plate 1c as shown in FIG. 8A.

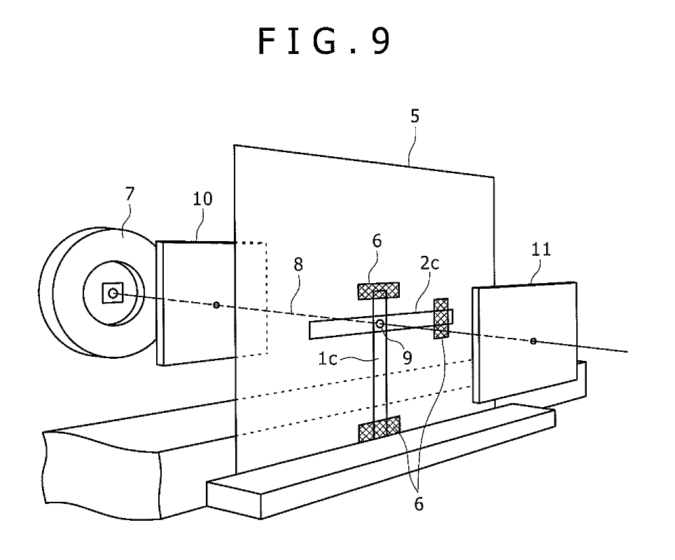

As shown in FIG. 9, the thus configured wave plates 100 and 110 were fixed to a glass whiteboard 5 and set in a spectrophotometer. The first quartz plate 1c and the second quartz plate 2c were simply fixed to the glass whiteboard 5 by a mending tape 6.

A polarization plate 10 was disposed on the incidence side of light 8 emitted from a light source 7 of the spectrophotometer to the wave plates 100 and 110, and an analyzer 11 was disposed on the output side of the light 8 transmitted through the wave plates 100 and 110.

The light 8 output from the light source 7 is transmitted through the polarization plate 10 and then incident on the intersection part between the first quartz plate 1c and the second quartz plate 2c as shown by a spot 9. The light transmitted through this intersection part is incident on the analyzer 11 and the light transmitted through the analyzer 11 is detected by a light receiver (not shown).

This analyzer 11 was rotated in a direction in its incident surface and the transmittance of the wave plates 100 and 110 in parallel Nicols and crossed Nicols were measured.

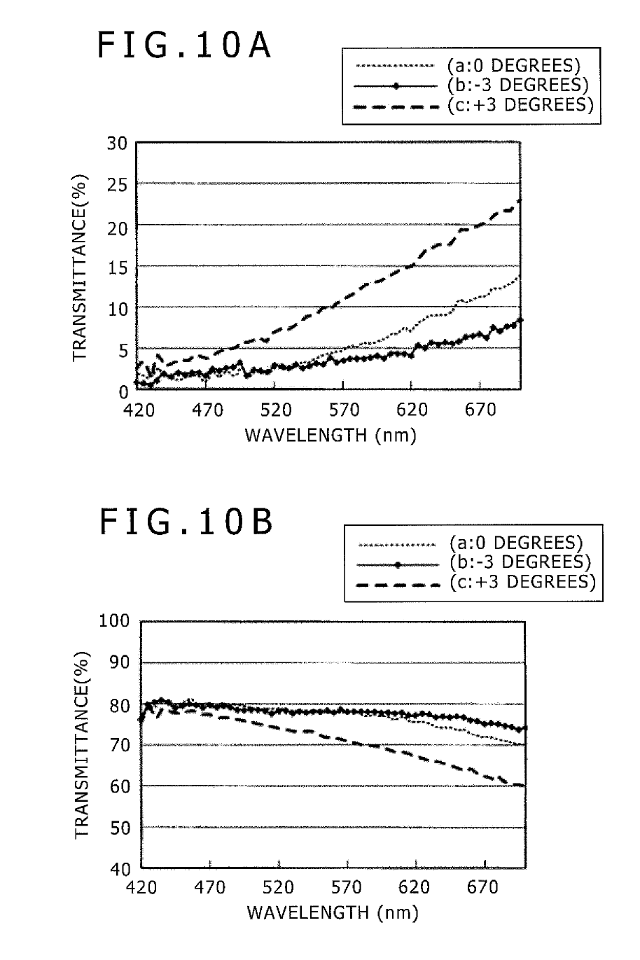

FIGS. 10A and 10B show the result of the actual measurement of the transmittance of the wave plate 100 according to the present embodiment.

FIG. 10A shows the transmittance in parallel Nicols and FIG. 10B shows the transmittance in crossed Nicols. Lines a, b, and c correspond to the cases in which the incident angle of light to the wave plate 100 is 0 degrees, −3 degrees, and +3 degrees, respectively.

Because the superimposing of the first quartz plate 1c and the second quartz plate 2c was simply performed by the mending tape 6, the transmittance in FIG. 10A is higher than that in FIG. 4A showing the simulation result in all of the lines a, b, and c.

However, the following tendency is the same as that of the simulation result. Specifically, when the incident angle of light is 0 degrees and −3 degrees, the wavelength dependence of the transmittance is small. When the incident angle of light is +3 degrees, the wavelength dependence of the transmittance is large and the transmittance is higher on the longer wavelength side.

Also in FIG. 10B showing the transmittance in crossed Nicols, the following tendency is the same as that of the simulation result although the transmittance is lower compared with FIG. 4B. Specifically, when the incident angle of light is 0 degrees and −3 degrees, the wavelength dependence of the transmittance is small. When the incident angle of light is +3 degrees, the wavelength dependence of the transmittance is large and the transmittance is lower on the longer wavelength side.

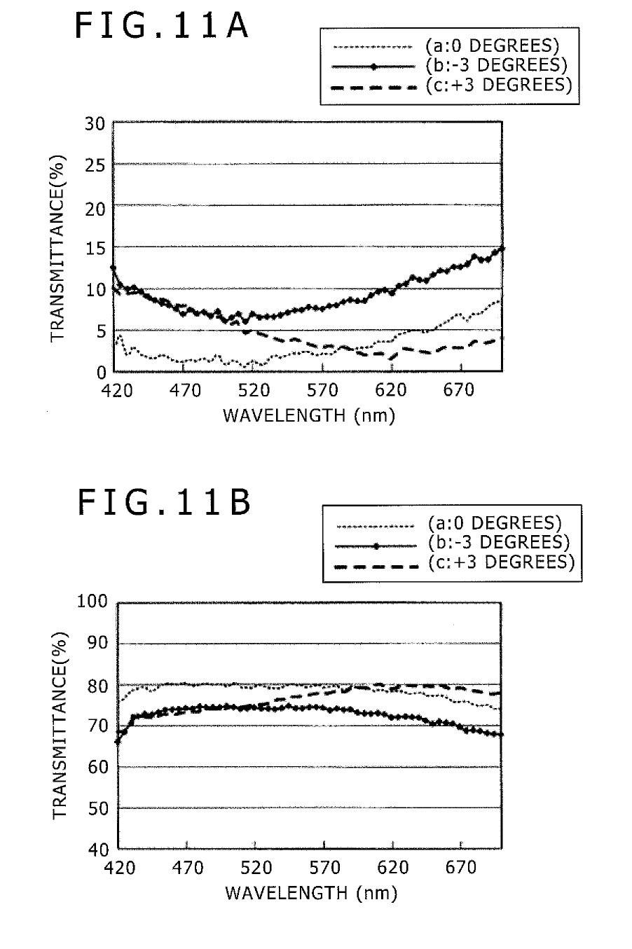

FIGS. 11A and 11B show the result of the actual measurement of the transmittance of the wave plate 110 having the related-art configuration.

FIG. 11A shows the transmittance in parallel Nicols and FIG. 11B shows the transmittance in crossed Nicols. Lines a, b, and c correspond to the cases in which the incident angle of light to the wave plate 110 is 0 degrees, −3 degrees, and +3 degrees, respectively.

In FIG. 11A, although the transmittance is totally higher, the tendency is almost the same as that of the simulation result of FIG. 5A. Specifically, the transmittance of the light whose incident angle is +3 degrees is higher on the shorter wavelength side for example.

Also in FIG. 11B showing the case of crossed Nicols, although the transmittance is totally lower, the tendency is almost the same as that of the simulation result of FIG. 5B. Specifically, the transmittance of the light whose incident angle is +3 degrees is lower on the shorter wavelength side for example.

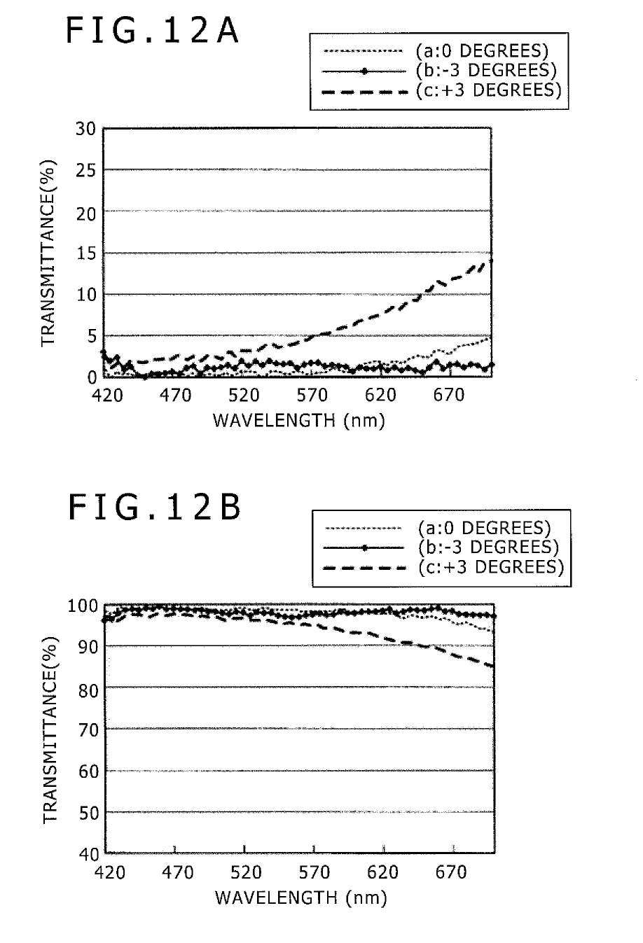

FIGS. 12A and 12B show the result obtained by measuring the transmittance similarly to FIG. 9 about the wave plate 100 of the present embodiment fabricated by actually bonding the first quartz plate 1c to the second quartz plate 2c and forming an antireflection film on its surface. The bonding of the first quartz plate 1c and the second quartz plate 2c was performed by a UV adhesive.

FIG. 12A shows the transmittance of the wave plate 100 of parallel Nicols and FIG. 12B shows the transmittance of the wave plate 100 of crossed Nicols.

According to FIG. 12A, it turns out that the transmittance of the light whose incident angle is 0 degrees and −3 degrees is totally low and high conversion efficiency almost equivalent to that of the simulation result of FIG. 4A can be achieved. Furthermore, the tendency that the transmittance of the light whose incident angle is +3 degrees is higher on the longer wavelength side also matches the simulation result well.

Because an antireflection film was provided, the transmittance is totally higher by about 10% in FIG. 12B showing the case of crossed Nicols. However, the wavelength dependence hardly exists and the transmittance is high for the light whose incident angle is 0 degrees and −3 degrees. Furthermore, the tendency that the transmittance of the light whose incident angle is +3 degrees is lower on the longer wavelength side matches the simulation result of FIG. 4B well.

As described above, according to the wave plate 100 of the present embodiment, the wavelength dependence for light whose incident angle is on the negative side smaller than 0 degrees can be reduced by configuring two quartz plates in such a manner that the optical axes of the quartz plates are parallel to each other when the quartz plates are seen from the direction parallel to their major surfaces.

For example if the wave plate 100 is rotated in a direction in its major surface and disposed so that intense light may be incident along the direction at an incident angle of −3 degrees, the characteristics for the light whose incident angle is −3 degrees and 0 degrees, shown in FIGS. 12A, 12B and so forth, are dominant and favorable polarization conversion efficiency can be achieved in the whole visible light range.

Although the data have been shown above about the wavelength range from 420 nm to 700 nm, the same advantageous effects can be achieved up to 400 nm or shorter regarding the limit on the shorter wavelength side.

Furthermore, the wave plate 100 has a simple configuration obtained by rotating two wave plates made by the same Z-cut in a direction in the major surface and superimposing these wave plates. Thus, the manufacturing is also easy and cost reduction can also be achieved.

In the technique of the above-described Patent Document 1, the thickness of one quartz plate needs to be set to about 0.1 mm because of the complexity of the design and an aim of suppressing wavelength dispersion. This thickness is close to the manufacturing limit in a general manufacturing method and therefore the productivity is poor.

However, in the wave plate 100 according to the present embodiment, even with a quartz plate whose single-plate thickness is about 0.15 mm, the wavelength dependence can be sufficiently reduced and the productivity can be enhanced as described above. When the single-plate thickness of the quartz plate in the present embodiment is in at least the range from 0.1 mm to 0.3 mm, the wavelength dependence for light whose incident angle is on the negative side smaller than 0 degrees can be reduced.

In the above description, examples in which quartz plates made by Z-cut at 25 degrees with respect to the optical axis are used are taken. However, this angle may be accordingly set in the range from 15 degrees to 30 degrees for example.

The same advantageous effects can be achieved also when the combination of the azimuth of the optical axis of the first quartz plate and the azimuth of the optical axis of the second quartz plate is (22.5 degrees, 67.5 degrees), (112.5 degrees, 157.5 degrees), or (157.5 degrees, 112.5 degrees).

### 2. Second Embodiment

### Example of Polarization Conversion Element

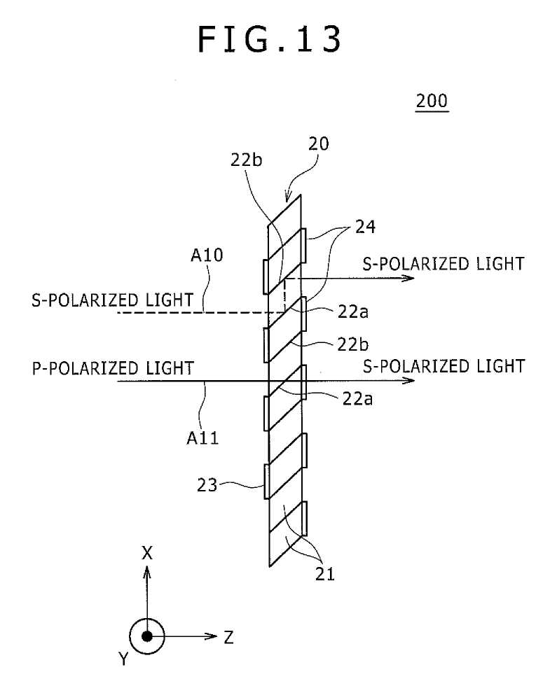

An example in which a polarization conversion element is configured by using the above-described wave plate 100 will be described below. FIG. 13 is a schematic configuration diagram showing the configuration of a polarization conversion element 200 according to a second embodiment of the present disclosure.

The polarization conversion element 200 according to the present embodiment includes a polarization splitter 20 that splits incident light into p-polarized light and s-polarized light, and wave plates 24 provided on the optical path of one of the p-polarized light and the s-polarized light split by the polarization splitter 20.

The polarization splitter 20 is configured by bonding plural prisms 21 having e.g. a parallelepiped shape to each other. At the bonding surfaces between the prisms 21, a PBS surface 22a that reflects the s-polarized light and transmits the p-polarized light and a reflective surface 22b that reflects the s-polarized light reflected by the PBS surface 22a again are alternately formed for example.

At the output surface of the prism 21 from which the p-polarized light transmitted through the PBS surface 22a is output, the wave plate 24 is provided. As this wave plate 24, the wave plate 100 shown in the first embodiment (FIGS. 1A and 1B) can be used. In this example, the wave plate 100 is rotated in an in-surface direction and provided so that the polarization direction of the p-polarized light may correspond with the X-axis direction of the wave plate 100 in FIGS. 1A and 1B.

A light blocking plate 23 may be provided at the surface of the light incidence side of the prism 21 provided with the wave plate 24 on its output surface.

As shown by an arrow A10, s-polarized light incident on the polarization conversion element 200 in the present embodiment is reflected by the PBS surface 22a of the prism 21 and is incident on the reflective surface 22b. Then the s-polarized light is reflected by the reflective surface 22b again and directly output as the s-polarized light.

On the other hand, as shown by an arrow A1l, p-polarized light incident on the polarization conversion element 200 according to the present embodiment is transmitted through the PBS surface 22a of the prism 21 and is incident on the wave plate 24. In the p-polarized light incident on the wave plate 24, a phase difference by 180 degrees (λ/2) is generated on the basis of a virtual axis at an azimuth of 45 degrees with respect to the X-axis. As a result, axisymmetric polarization change occurs, so that the light is output as s-polarized light.

In this manner, in the polarization conversion element 200 according to the present embodiment, light including both p-polarized light and s-polarized light is converted to light of one of these polarization directions.

In particular, the wave plate 100 shown in the first embodiment is used as the wave plate 24. Thus, the wavelength dependence can be reduced for light whose incident angle is on the negative side. Therefore, high polarization conversion efficiency can be realized by disposing the polarization conversion element in such a manner that light is incident on the wave plate 24 at an incident angle on the negative side smaller than 0 degrees, preferably at −3 degrees.

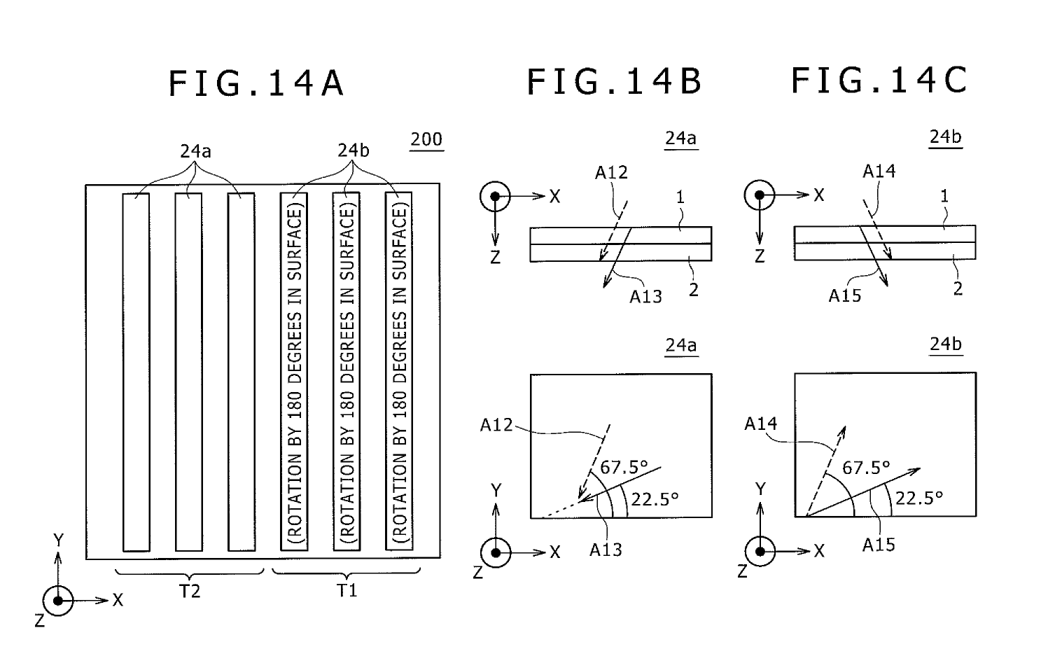

FIG. 14A is a schematic front view when this polarization conversion element 200 is seen from the side of the wave plate 24.

The polarization conversion element 200 is divided into two areas, T1 and T2. The wave plates 24 are disposed in each of the area T1 and the area T2. For convenience, the following description will be separately given about wave plates 24a disposed in the area T2 and about wave plates 24b disposed in the area T1. However, these wave plates 24a and 24b are the same as the wave plate 100 shown in the first embodiment and are obtained by processing the outer shape into a rectangular shape.

In the area T2, as shown in FIG. 14B, the wave plate 24a is disposed in the same orientation as that of the wave plate 100 shown in the first embodiment (FIGS. 1A and 1B) regarding the coordinate directions in the diagram. An arrow A12 indicates the optical axis direction of the first quartz plate 1 configuring the wave plate 24a, and an arrow A13 indicates the optical axis direction of the second quartz plate 2 configuring the wave plate 24a.

The wave plate 24b in the area T1 is disposed in the orientation resulting from rotation of the wave plate 24a disposed in the area T2 by 180 degrees in a direction in its major surface (direction in the XY plane). At this time, the optical axes of the first quartz plate 1 and the second quartz plate 2 configuring the wave plate 24b are in the orientations of arrows A14 and A15, respectively, shown in FIG. 14C.

Therefore, the wave plate 24a in the area T2 provides high conversion efficiency for light whose incident angle is on the negative side smaller than 0 degrees. The wave plate 24b in the area T1 exhibits favorable conversion efficiency for light whose incident angle is on the positive side larger than 0 degrees because the wave plate 24b results from rotation of the wave plate 24a by 180 degrees in a direction in the major surface.

In general, due to the configuration of an optical system such as the eccentricity of a lens in the optical system, the distribution of the incident angle of light incident on the polarization conversion element is uneven. Therefore, the distribution of the incident angle of light incident on the polarization conversion element is not necessarily uniform in its major surface.

However, by accordingly changing the disposing orientation of the wave plate 24 in the polarization conversion element 200 like in the present embodiment, polarization conversion in association with the incident angle distribution of light in the major surface can be carried out, and thus the conversion efficiency can be further enhanced.

Besides the combination of the directions of the optical axes of the wave plates 24a and 24b shown here, combinations that provide equivalent advantageous effects exist. These combinations are obtained by e.g. rotation of the wave plates 24a and 24b in a direction in their major surfaces (XY plane).

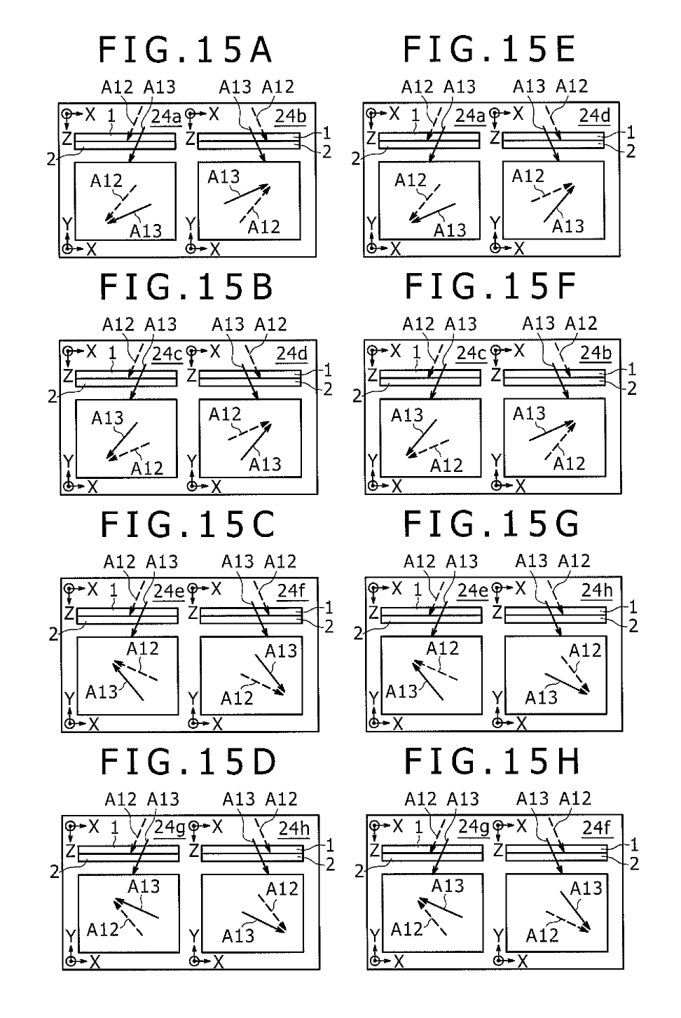

These combinations are exemplified in FIGS. 15A to 15H. In the following description, the orientation of the optical axis of the first quartz plate 1 is shown by the arrow A12, and the orientation of the optical axis of the second quartz plate 2 is shown by the arrow A13. In this example, the optical axes of the first quartz plate 1 and the second quartz plate 2 in the top view seen from the direction parallel to the major surface are parallel and the same in all combinations. However, the combination of the optical axes in the front view seen from the direction perpendicular to the major surface is different.

FIG. 15A shows the combination shown in FIGS. 14A to 14C. Therefore, the azimuth of the optical axis of the first quartz plate 1 shown by the arrow A12 is 67.5 degrees and the azimuth of the optical axis of the second quartz plate 2 shown by the arrow A13 is 22.5 degrees.

The wave plate 24b results from rotation of the wave plate 24a by 180 degrees in a direction in its major surface. As already described, as definition in the present specification, the azimuth is irrespective of the orientation of the optical axis in the Z-axis direction, and the optical axis whose arrowhead is oriented to the 180 degrees opposite side in the diagram has the same azimuth. Therefore, the azimuth of the optical axis shown by the arrow A12 is 67.5 degrees similarly and the azimuth of the optical axis shown by the arrow A13 is 22.5 degrees.

As shown in FIG. 15B, it is also possible to employ a configuration obtained by interchanging the orientation of the optical axis of the first quartz plate 1 and the orientation of the optical axis of the second quartz plate 2 in the front view. In a wave plate 24c, the azimuth of the optical axis of the first quartz plate 1 (arrow A12) is 22.5 degrees and the azimuth of the optical axis of the second quartz plate 2 (arrow A13) is 67.5 degrees.

A wave plate 24d results from rotation of this wave plate 24c by 180 degrees in a direction in the major surface. The azimuth of the optical axis of the first quartz plate 1 (arrow A12) is 22.5 degrees and the azimuth of the optical axis of the second quartz plate 2 (arrow A13) is 67.5 degrees.

FIG. 15C shows the configuration obtained by rotating the wave plates 24a and 24b in FIG. 15A by 90 degrees in a direction in the major surface (direction in the XY plane). Therefore, in a wave plate 24e, the azimuth of the optical axis of the first quartz plate 1 is 157.5 degrees (−22.5 degrees) shown by the arrow A12, and the azimuth of the optical axis of the second quartz plate 2 is 112.5 degrees (−67.5 degrees) shown by the arrow A13.

A wave plate 24f results from rotation of the wave plate 24e by 180 degrees in a direction in the major surface. Therefore, the azimuth of the optical axis of the first quartz plate 1 (arrow A12) and the azimuth of the optical axis of the second quartz plate 2 (arrow A13) are 157.5 degrees and 112.5 degrees, respectively, similarly.

FIG. 15D shows the configuration obtained by rotating the wave plates 24c and 24d in FIG. 15B by 90 degrees in a direction in the major surface. In a wave plate 24g, the azimuth of the optical axis of the first quartz plate 1 (arrow A12) is 112.5 degrees (−67.5 degrees), and the azimuth of the optical axis of the second quartz plate 2 (arrow A13) is 157.5 degrees (−22.5 degrees).

A wave plate 24h results from rotation of the wave plate 24g by 180 degrees in its major surface. Therefore, the azimuth of the optical axis of the first quartz plate 1 (arrow A12) is also 112.5 degrees similarly, and the azimuth of the optical axis of the second quartz plate 2 (arrow A13) is 157.5 degrees.

FIG. 15E shows the combination of the wave plate 24a in FIG. 15A and the wave plate 24d in FIG. 15B.

FIG. 15F shows the combination of the wave plate 24c in FIG. 15B and the wave plate 24b in FIG. 15A.

FIG. 15G shows the combination of the wave plate 24e in FIG. 15C and the wave plate 24h in FIG. 15D.

FIG. 15H shows the combination of the wave plate 24g in FIG. 15D and the wave plate 24f in FIG. 15C.

Specifically, the wave plates 24c, 24e, and 24g exist as wave plates equivalent to the wave plate 24a, and the wave plates 24d, 24f, and 24h exist as wave plates equivalent to the wave plate 24b. Therefore, 4×4=16 combinations exist in total. FIGS. 15A to 15H show eight combinations of these 16 combinations.

### 3. Third Embodiment

### Example of Illumination Optical System

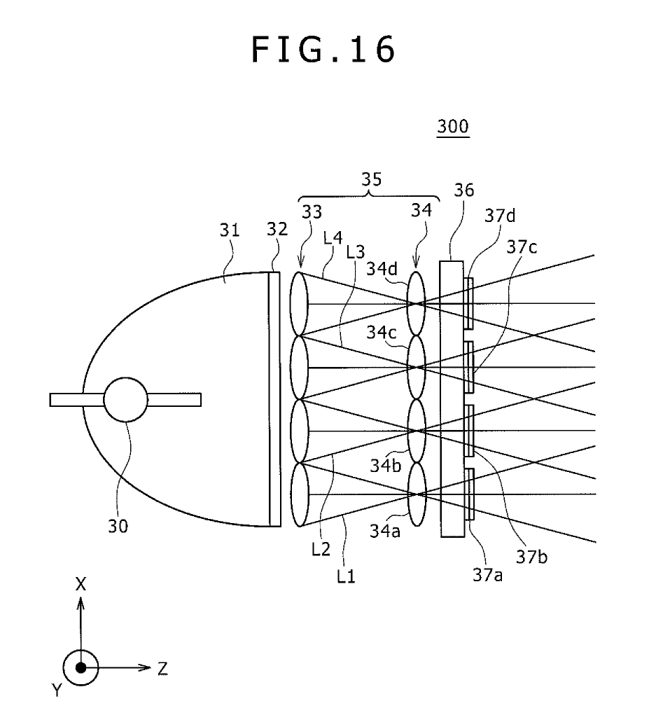

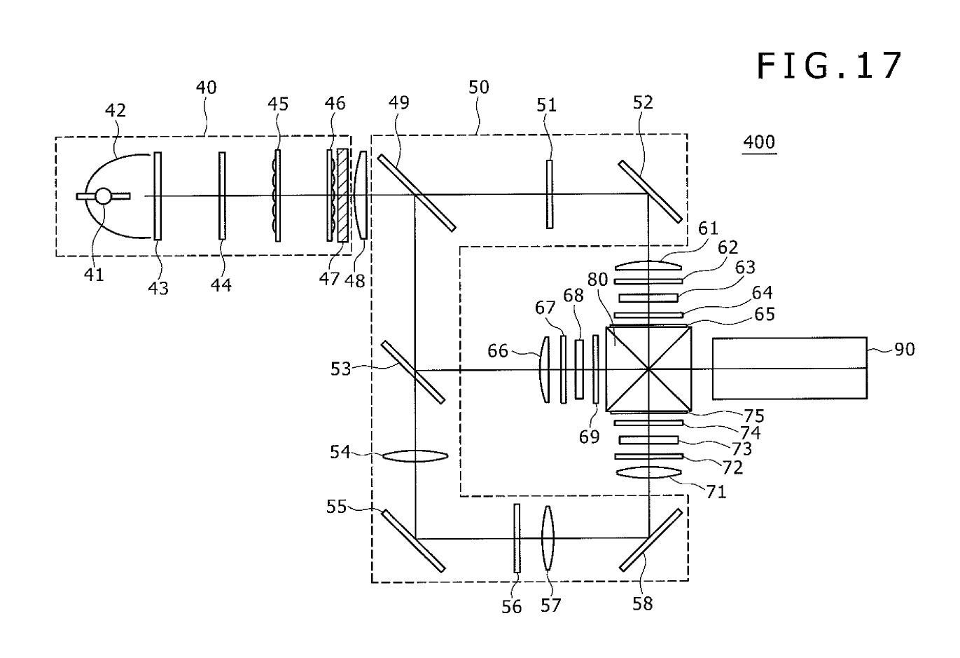

With reference to FIG. 16, a description will be given below about an example in which an illumination optical system that can be applied to e.g. an image display device such as a projector is configured by using the wave plate 100 according to one embodiment of the present disclosure.

FIG. 16 is a schematic configuration diagram showing the configuration of an illumination optical system 300 according to a third embodiment. The illumination optical system 300 according to the present embodiment includes a light source 30 that emits light, an integrator element 35 that reduces luminance unevenness of the light emitted from the light source 30, and a polarization conversion element 36 that aligns the polarization direction of light transmitted through the integrator element 35.

As the light source 30, e.g. an ultra-high-pressure mercury lamp is used. The light emitted from the light source is reflected by a reflector 31 and output through an explosion-proof glass 32 covering the light output opening of the reflector. The explosion-proof glass 32 is provided in order to protect the light source 30 from damage and so forth.

For the light transmitted through the explosion-proof glass 32, unevenness of the luminance distribution in the XY plane in the diagram is reduced by the integrator element 35. In the present embodiment, the integrator element 35 is composed of a first fly eye lens 33 and a second fly eye lens 34.

An ultraviolet cut filter and so forth may be provided between the light source 30 and the integrator element 35.

The light transmitted through the integrator element 35 is converted to light whose polarization direction is aligned to one direction by the polarization conversion element 36 and output from the illumination optical system 300.

As this polarization conversion element 36, the polarization conversion element 200 shown in the second embodiment can be used.

In this polarization conversion element 36, wave plates 37a to 37d are provided corresponding to the individual lenses 34a to 34d configuring the second fly eye lens for example.

For light from the lenses 34a and 34b, the wave plates 37a and 37b, respectively, that are the same as the wave plate 100 shown in the first embodiment (FIGS. 1A and 1B) are disposed in the same coordinate axis directions as those of the wave plate 24a shown in the second embodiment (FIGS. 14A to 14C).

For light from the lenses 34c and 34d, the wave plates 37c and 37d, respectively, resulting from rotation of the wave plates 37a and 37b by 180 degrees in a direction in the major surface (direction in the XY plane) are disposed. That is, the wave plates 37c and 37d are equivalent to the wave plate 24b shown in FIGS. 14A to 14C.

The luminance distribution of the light emitted from the light source 30 does not become completely uniform although the light passes through the integrator element 35. For example, the intensity of a light beam traveling from the outside toward the inside like light beams L1 to L4 in FIG. 16 is often higher than that of the other light beams.

Specifically, in light beams incident on the wave plates 37a and 37b, the intensity of the light beams L1 and L2, whose incident angle is on the negative side smaller than 0 degrees, is higher. Therefore, by disposing the wave plates 37a and 37b in such a manner that the optical axes of the quartz plates configuring the wave plates 37a and 37b are in the same orientation as that of the wave plate 24a shown in the second embodiment (FIGS. 14A to 14C), the light beams L1 and L2 can be preferentially subjected to polarization conversion and the conversion efficiency can be enhanced.

In light beams incident on the wave plates 37c and 37d, the intensity of the light beams L3 and L4, whose incident angle is on the positive side larger than 0 degrees, is higher. Therefore, by rotating the wave plate 37a (37b) by 180 degrees in a direction in its major surface and disposing it so that its optical axis may be in the same orientation as that of the wave plate 24b shown in the second embodiment (FIGS. 14A to 14C), the light beams L3 and L4 can be preferentially subjected to polarization conversion and the conversion efficiency can be enhanced.

In this manner, in the present embodiment, the polarization conversion efficiency can be enhanced by disposing the wave plates 37a to 37d in association with the incident angle of light having high intensity. Thus, the luminance of the illumination can be enhanced.

### 4. Fourth Embodiment

### Example of Image Display Device

Brighter, clearer images are displayed by configuring an image display device such as a projector by using the above-described illumination optical system. FIG. 17 is a schematic configuration diagram showing the configuration of an image display device 400 according to a fourth embodiment.

The image display device 400 according to the present embodiment includes an illumination optical system 40 that outputs polarized light, a light-splitting optical system that splits the light output by the illumination optical system 40, liquid crystal panels 63, 68, and 73 that modulate the light beams split by the light-splitting optical system 50.

Furthermore, the image display device 400 includes a light combiner 80 that combines the respective light beams modulated by the liquid crystal panels 63, 68, and 73, and a projecting lens 90 that projects the light resulting from the combining by the light combiner 80.

As the illumination optical system 40, the illumination optical system 300 shown in the third embodiment (FIG. 16) can be used. White light emitted from a light source such as an ultra-high-pressure mercury lamp is reflected by a reflector 42 and transmitted through an explosion-proof glass 43 to be output. In the present embodiment, a UV cut filter 44 is disposed in the illumination optical system 40 and ultraviolet rays are removed from the light transmitted through the explosion-proof glass 43.

The light transmitted through the UV cut filter 44 is incident on a polarization conversion element 47 after its luminance unevenness is reduced by a first fly eye lens 45 and a second fly eye lens 46. As the polarization conversion element 47, the polarization conversion element 200 shown in the second embodiment (FIG. 13) is used. The polarization conversion element 47 converts the incident light to e.g. s-polarized light, and this s-polarized light is output from the illumination optical system 40.

The light output from the illumination optical system 40 is collimated by e.g. a condenser lens 48 and is incident on the light-splitting optical system 50.

The light-splitting optical system 50 includes a dichroic mirror 49 and a dichroic mirror 53. For example, the dichroic mirror 49 transmits blue light in the white light from the illumination optical system 40 and reflects red light and green light. The dichroic mirror 53 is disposed on the optical path of the light reflected by the dichroic mirror 49. It reflects green light and transmits red light.

The light incident on the light-splitting optical system 50 is first incident on the dichroic mirror 49 for example. The dichroic mirror 49 transmits blue light and reflects red light and green light.

The blue light transmitted through the dichroic mirror 49 is transmitted through a UV absorbing filter 51, and thereby ultraviolet rays are cut. The blue light transmitted through the UV absorbing filter 51 is reflected by a mirror 52 and thus its travelling path is changed, so that the blue light is incident on a condenser lens 61.

The polarization direction of the blue light collected by the condenser lens 61 is aligned into linearly-polarized light by an incidence-side polarization plate 62 and is incident on the liquid crystal panel 63. At the subsequent stage of the liquid crystal panel 63, an output-side polarization plate 64 is disposed as an analyzer. The output-side polarization plate 64 transmits only light of a predetermined polarization direction, of the light transmitted through the liquid crystal panel 63.

The polarization planes of the incidence-side polarization plate 62 and the output-side polarization plate are so disposed as to correspond with each other for example. As the liquid crystal panel 63, e.g. a panel of the twisted nematic type can be used. In this case, a signal voltage for blue light dependent on image information is applied to each pixel of the liquid crystal panel 63 for example, and the polarization direction of blue light transmitted through each pixel is rotated depending on this voltage. By making this blue light whose polarization direction differs from pixel to pixel be transmitted through the output-side polarization plate 64, blue light having the intensity distribution dependent on the image information can be achieved.

The blue light transmitted through the output-side polarization plate 64 is transmitted through a half-wave film provided on the incident surface of the combining prism 80 for example. Thereby, its polarization direction is rotated by 90 degrees, and thereafter the blue light is incident on the combining prism 80.

The red light and the green light reflected by the dichroic mirror 49 are incident on the dichroic mirror 53. The dichroic mirror 53 reflects green light and transmits red light.

The green light reflected by the dichroic mirror 53 is incident on a condenser lens 66.

The green light collected by the condenser lens 66 is converted to linearly-polarized light by an incidence-side polarization plate 67 and is incident on the liquid crystal panel 68. The liquid crystal panel 68 rotates the polarization direction of green light transmitted through each pixel in accordance with image information. The green light transmitted through the liquid crystal panel 68 is transmitted through an output-side polarization plate 69 to thereby become green image light having the intensity distribution dependent on the image information and is incident on the combining prism 80.

The red light transmitted through the dichroic mirror 53 is transmitted through a collecting lens 54 and then reflected by a mirror 55.

A wavelength selection filter 56 such as a band-pass filter is disposed on the optical path of the red light reflected by the mirror 55 and transmits only effective red light to the subsequent stage.

The red light transmitted through the wavelength selection filter 56 is transmitted through a collecting lens 57 and then reflected by a mirror 58, so that its travelling path is changed.

This red light is diffused more easily than green light and blue light because its optical path is longer. Therefore, the red light is made to converge by the collecting lenses 54 and 57.

The red light reflected by the mirror 58 is collected by a condenser lens 71 and then is incident on an incidence-side polarization plate 72. The red light is transmitted through the incidence-side polarization plate 72 to thereby become linearly-polarized light and be incident on the liquid crystal panel 73.

In the liquid crystal panel 73, a voltage signal based on image information is applied to each pixel. Furthermore, the polarization direction of transmitted red light is rotated in accordance with the voltage signal. The red light transmitted through the liquid crystal panel 73 is incident on an output-side polarization plate 74 to become red image light having the intensity distribution dependent on the image information.

The polarization direction of the red light transmitted through the output-side polarization plate 74 is rotated by 90 degrees by a half-wave film 75 provided on the incident surface of the combining prism 80 for example, and thereafter the red light is incident on the combining prism 80.

The combining prism 80 transmits green light, which is p-polarized light, and reflects blue light and red light, which are s-polarized light, to thereby combine the red light, the green light, and the blue light onto the same optical path. The combined light output from the combining prism is projected in an enlarged manner onto e.g. a screen by the projecting lens 90.

As just described, in the image display device 400 according to the present embodiment, the illumination optical system shown in the third embodiment (FIG. 16) is used. In this illumination optical system 40, the polarization conversion efficiency of light from the light source 41 is high. Thus, the illumination optical system 40 can output light with high luminance at low power consumption. Therefore, the image display device 400 according to the present embodiment can provide brighter, clearer images at low cost.

The wave plate, the polarization conversion element, the illumination optical system, and the image display device according to embodiments of the present disclosure have been described above. However, the present disclosure is not limited by the above-described embodiments and encompasses various possible modes without departing from the gist of the present disclosure set forth in the claims.

The present disclosure contains subject matter related to that disclosed in Japanese Priority Patent Application JP 2010-221508 filed in the Japan Patent Office on Sep. 30, 2010, the entire content of which is hereby incorporated by reference.

What is claimed is:

1. A wave plate comprising:
a first quartz plate configured to have a crystal optical axis inclined to a major surface; and
a second quartz plate configured to have a crystal optical axis inclined to a major surface, the major surface of the second quartz plate being superimposed on the major surface of the first quartz plate,
wherein an angle formed by the optical axis of the first quartz plate and the optical axis of the second quartz plate is 45 degrees in a front view seen from direction perpendicular to the major surface, and the optical axis of the first quartz plate is parallel to the optical axis of the second quartz plate in a top view seen from direction parallel to the major surface.

2. The wave plate according to claim 1, wherein when an azimuth of the optical axis of the first quartz plate in the front view is 22.5 degrees, 67.5 degrees, 112.5 degrees, or 157.5 degrees, the azimuth of the optical axis of the second quartz plate in the front view is 67.5 degrees, 22.5 degrees, 157.5 degrees, or 112.5 degrees, respectively.

3. The wave plate according to claim 1, wherein the first and second quartz plates yield a phase difference by 180 degrees for light with a desired wavelength.

4. The wave plate according to claim 1, wherein the optical axes of the first and second quartz plates are inclined to the major surfaces of the first and second quartz plates by an angle of 15 degrees to 30 degrees.

5. The wave plate according to claim 1, wherein the first and second quartz plates have an identical thickness and an identical optical axis slope in thickness direction.

6. The wave plate according to claim 1, wherein single-plate thickness of the first quartz plate and the second quartz plate is 0.1 mm to 0.3 mm.

7. A polarization conversion element comprising:
a polarization splitter configured to split incident light into p-polarized light and s-polarized light; and
a wave plate configured to be disposed on an optical path of one of the p-polarized light and the s-polarized light split by the polarization splitter, wherein
the wave plate includes a first quartz plate having a crystal optical axis inclined to a major surface and a second quartz plate having a crystal optical axis inclined to a major surface, and the major surface of the second quartz plate is superimposed on the major surface of the first quartz plate, and
an angle formed by the optical axis of the first quartz plate and the optical axis of the second quartz plate is 45 degrees in a front view seen from direction perpendicular to the major surface, and the optical axis of the first quartz plate is parallel to the optical axis of the second quartz plate in a top view seen from direction parallel to the major surface.

8. The polarization conversion element according to claim 7, wherein
a plurality of the polarization splitters and a plurality of the wave plates are provided, and
the wave plate is rotated in a direction in the major surface and disposed in such a manner that incident angle and intensity of incident light match a viewing angle characteristic of the wave plate.

9. An illumination optical system comprising:
a light source;
an integrator element configured to reduce illuminance unevenness of light emitted from the light source; and
a polarization conversion element configured to be disposed on an optical path of light transmitted through the integrator element and include a polarization splitter that splits incident light into p-polarized light and s-polarized light and a wave plate disposed on an optical path of one of the p-polarized light and the s-polarized light split by the polarization splitter, wherein
the wave plate includes a first quartz plate having a crystal optical axis inclined to a major surface and a second quartz plate having a crystal optical axis inclined to a major surface, and the major surface of the second quartz plate is superimposed on the major surface of the first quartz plate, and
an angle formed by the optical axis of the first quartz plate and the optical axis of the second quartz plate is 45 degrees in a front view seen from direction perpendicular to the major surface, and the optical axis of the first quartz plate is parallel to the optical axis of the second quartz plate in a top view seen from direction parallel to the major surface.

10. The polarization conversion element according to claim 9, wherein
the polarization conversion element includes a plurality of the polarization splitters and a plurality of the wave plates, and
the wave plate is rotated in a direction in the major surface and disposed in such a manner that incident angle and intensity of incident light match a viewing angle characteristic of the wave plate.

11. An image display device comprising:
an illumination optical system configured to include
a light source,
an integrator element that reduces illuminance unevenness of light emitted from the light source, and
a polarization conversion element that is disposed on an optical path of light transmitted through the integrator element and includes a polarization splitter that splits incident light into p-polarized light and s-polarized light and a wave plate disposed on an optical path of one of the p-polarized light and the s-polarized light split by the polarization splitter;
a light-splitting optical system configured to split light output from the illumination optical system;
a liquid crystal panel configured to modulate the split light;
a light combiner configured to combine light modulated by the liquid crystal panel; and
a lens configured to project light combined by the light combiner, wherein
the wave plate includes a first quartz plate having a crystal optical axis inclined to a major surface and a second quartz plate having a crystal optical axis inclined to a major surface, and the major surface of the second quartz plate is superimposed on the major surface of the first quartz plate, and
an angle formed by the optical axis of the first quartz plate and the optical axis of the second quartz plate is 45 degrees in a front view seen from direction perpendicular to the major surface, and the optical axis of the first quartz plate is parallel to the optical axis of the second quartz plate in a top view seen from direction parallel to the major surface.
